(19) United States
(12) Patent Application Publication
(10) Pub. No.: US 2024/0369843 A1
(43) Pub. Date: Nov. 7, 2024

(54) A HEAD MOUNTABLE DEVICE COMPRISING ADJUSTABLE AND MODULAR LENSES

(71) Applicant: Apple Inc., Cupertino, CA (US)

(72) Inventors: Joshua N. HADDOCK, Cupertino, CA (US); Nikhil D. KALYANKAR, Fremont, CA (US)

(21) Appl. No.: 18/689,397

(22) PCT Filed: Sep. 7, 2022
(86) PCT No.: PCT/US2022/042798

§ 371 Date: Mar. 5, 2024

Related U.S. Application Data
(60) Provisional application No. 63/247,208, filed on Sep. 22, 2021.

(51) Int. Cl. G02B 27/01; G02B 3/02

(52) U.S. Cl. CPC G02B 27/0172; G02B 3/02; G02B 2027/0138; G02B 2027/014

(57) ABSTRACT

A wearable electronic device can include an optical assembly that combines installable lens assemblies with built-in adjustable lenses that provide vision correction appropriate for any given user. By providing wearable electronic devices with modular features and adjustable vision correction, certain lens assemblies can provide the desired vision correction for any given user and facilitate exchange with a different lens assembly for a different user.

### CROSS-REFERENCE TO RELATED APPLICATION

This application claims the benefit of U.S. Provisional Application No. 63/247,208, entitled “HEAD-MOUNTABLE DEVICES WITH ADJUSTABLE AND MODULAR LENSES,” filed Sep. 22, 2021, the entirety of which is incorporated herein by reference.

### TECHNICAL FIELD

The present description relates generally to head-mountable devices, and, more particularly, to head-mountable devices with adjustable lens assemblies.

### BACKGROUND

A head-mountable device can be worn by a user to display visual information within the field of view of the user. The head-mountable device can be used as a virtual reality (VR) system, an augmented reality (AR) system, and/or a mixed reality (MR) system. A user may observe outputs provided by the head-mountable device, such as visual information provided on a display. The display can optionally allow a user to observe an environment outside of the head-mountable device. Other outputs provided by the head-mountable device can include speaker output and/or haptic feedback. A user may further interact with the head-mountable device by providing inputs for processing by one or more components of the head-mountable device. For example, the user can provide tactile inputs, voice commands, and other inputs while the device is mounted to the user's head.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a top view of a head-mountable device, according to some embodiments of the present disclosure.

FIG. 2 illustrates a rear view of the head-mountable device of FIG. 1, according to some embodiments of the present disclosure.

FIG. 3 illustrates a schematic view of a lens assembly of the head-mountable device of FIG. 1, according to some embodiments of the present disclosure.

FIG. 4 illustrates a view of an adjustable lens with lenses in a first configuration and an effective lens created thereby, according to some embodiments of the present disclosure.

FIG. 5 illustrates a view of the adjustable lens of FIG. 4 with lenses in a second configuration and an effective lens created thereby, according to some embodiments of the present disclosure.

FIG. 6 illustrates a schematic view of another lens assembly of the head-mountable device of FIG. 1, according to some embodiments of the present disclosure.

FIG. 7 illustrates a view of a head-mountable device providing a user interface with a display, according to some embodiments of the present disclosure.

FIG. 8 illustrates a view of the head-mountable device of FIG. 7 providing the user interface with the display, according to some embodiments of the present disclosure.

FIG. 9 illustrates a flow chart of a process including operations for controlling a head-mountable device, in accordance with some embodiments of the present disclosure.

FIG. 10 illustrates a block diagram of a head-mountable device, in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mountable devices, such as head-mountable displays, headsets, visors, smartglasses, head-up display, etc., can perform a range of functions that are managed by the components (e.g., sensors, circuitry, and other hardware) included with the wearable device.

Many of the functions performed by a head-mountable device are optimally experienced when the output is tailored to the needs of the user wearing the head-mountable device. In particular, the visual output features of a head-mountable device can be provided in a manner that accommodates a user's vision, including vision deficiencies and/or needs for vision correction. For example, a head-mountable device can include or be combinable with corrective lenses that allow a user to properly view the visual output features of the head-mountable device.

It can be costly to require each user to acquire an entire head-mountable device that is specifically tailored to their facial features. In particular, such an approach would require customization of each head-mountable device and/or the ability to choose from a wide variety of head-mountable devices.

To allow a given head-mountable device can be used by different users, the corrective lenses can be provided as a separate module that is attachable, removable, and/or exchangeable with other corrective lenses. Accordingly, any given user can properly view the visual output features when using the head-mountable device with an appropriate corresponding set of corrective lenses.

Additionally, the head-mountable device can provide a range of adjustable vision correction apart from custom lenses that are installed for use with a particular user. For example, the optical assembly of the head-mountable device can include adjustable lenses that provide adjustable spherical and/or cylindrical correction within a range. Accordingly, the user need not be provided with every possible increment of vision correction with a large number of candidate lens assemblies to be installed. Instead, a smaller number lens assemblies can be sufficient, where the difference in the lens assemblies available and the target vision correction can be accomplished by adjusting the optical assembly within the head-mountable device.

Systems, devices, and methods of the present disclosure can provide a head-mountable device with an optical assembly that combines installable lens assemblies with built-in adjustable lenses that provide vision correction appropriate for any given user. By providing head-mountable devices with modular features and adjustable vision correction, certain lens assemblies can provide the desired vision correction for any given user and facilitate exchange with a different lens assembly for a different user.

These and other embodiments are discussed below with reference to FIGS. 1-10. However, those skilled in the art will readily appreciate that the detailed description given herein with respect to these Figures is for explanatory purposes only and should not be construed as limiting.

According to some embodiments, for example as shown in FIG. 1, a head-mountable device 100 includes a frame 110 that is worn on a head of a user. The frame 110 can be positioned in front of the eyes of a user to provide information within a field of view of the user. The frame 110 can provide nose pads or another feature to rest on a user's nose and/or engage other parts of the user's face.

The frame 110 can be supported on a user's head with the head engager 120. The head engager 120 can wrap or extend along opposing sides of a user's head. The head engager 120 can optionally include earpieces for wrapping around or otherwise engaging or resting on a user's ears. It will be appreciated that other configurations can be applied for securing the head-mountable device 100 to a user's head. For example, one or more bands, straps, belts, caps, hats, or other components can be used in addition to or in place of the illustrated components of the head-mountable device 100. By further example, the head engager 120 can include multiple components to engage a user's head.

The frame 110 can provide structure around a peripheral region thereof to support any internal components of the head-mountable device 100 in their assembled position. For example, the frame 110 can enclose and support various internal components (including for example integrated circuit chips, processors, memory devices and other circuitry) to provide computing and functional operations for the head-mountable device 100, as discussed further herein. While several components are shown within the frame 110, it will be understood that some or all of these components can be located anywhere within or on the head-mountable device 100. For example, one or more of these components can be positioned within the head engager 120 of the head-mountable device 100.

The frame 110 can include and/or support one or more cameras 130. The cameras 130 can be positioned on or near an outer side 112 of the frame 110 to capture images of views external to the head-mountable device 100. As used herein, an outer side of a portion of a head-mountable device is a side that faces away from the user and/or towards an external environment. The captured images can be used for display to the user or stored for any other purpose. Each of the cameras 130 can be movable along the outer side 112. For example, a track or other guide can be provided for facilitating movement of the camera 130 therein.

The head-mountable device 100 can include displays 140 that provide visual output for viewing by a user wearing the head-mountable device 100. One or more displays 140 can be positioned on or near an inner side 114 of the frame 110. As used herein, an inner side 114 of a portion of a head-mountable device is a side that faces toward the user and/or away from the external environment.

A display 140 can transmit light from a physical environment (e.g., as captured by a camera) for viewing by the user. The display 140 can be operated to display visual information for a user. For example, the display 140 can provide visual (e.g., image or video) output by utilizing, for example, digital light projection, OLEDs, LEDS, uLEDs, liquid crystal on silicon, laser scanning light source, or any combination of these technologies. Such information can be provided to the exclusion of a view of a physical environment or in addition to (e.g., overlaid with) a view of a physical environment.

A physical environment refers to a physical world that people can interact with and/or sense without necessarily requiring the aid of an electronic device. A computer-generated reality environment relates to a partially or wholly simulated environment that people sense and/or interact with the assistance of an electronic device. Examples of computer-generated reality include, but are not limited to, mixed reality and virtual reality. Examples of mixed realities can include augmented reality and augmented virtuality. Examples of electronic devices that enable a person to sense and/or interact with various computer-generated reality environments include head-mountable devices, projection-based devices, heads-up displays (HUDs), vehicle windshields having integrated display capability, windows having integrated display capability, displays formed as lenses designed to be placed on a person's eyes (e.g., similar to contact lenses), headphones/earphones, speaker arrays, input devices (e.g., wearable or handheld controllers with or without haptic feedback), smartphones, tablets, and desktop/laptop computers. A head-mountable device can have an integrated opaque display, have a transparent or translucent display, or be configured to accept an external opaque display from another device (e.g., smartphone).

Referring again to FIG. 1, the head-mountable device 100 can include one or more optical assemblies 200. An optical assembly 200 can include optical properties, such as adjustable lenses for vision correction. The optical assembly 200 can be or include one or more adjustable lenses that are moveable relative to each other for providing corrective vision capabilities, as described further herein. It will be understood that, where multiple lenses are used, the lenses of the lens assembly 210 can be provided together or separately (e.g., for combination). One optical assembly 200 can be provided for each of multiple displays 140.

As further shown in FIG. 1, the head-mountable device 100 can be provided with one or more removeable and exchangeable lens assemblies 210 that can be installed into the optical assembly 200 and combined with other lenses (e.g., adjustable lenses) for providing corrective vision capabilities. One or more lens assemblies 210 can be provided to each of the optical assemblies 200.

The lens assembly 210 can provide one or more types of optical effects and/or vision correction. A lens assembly 210 can include other optical components as required to produce a desired optical effect. For example, a lens assembly 210 can provide vision correction as appropriate for a given user. Such correction can be spherical, aspheric, atoric, cylindrical, single vision, multifocal, progressive, and/or adjustable. By further example, lens assemblies 210 can include one or more diffusers, filters, polarizers, prisms, beam splitters, diffraction gratings, mirrors, and/or windows. The differences in correction or other effects among lens assemblies 210 can include variations in type of correction, diopter power, axis of correction, and the like. Various combinations of corrections can be provided with different lens assemblies 210.

As used herein, “modular” or “module” can refer to a characteristic that allows an item, such as a lens assembly 210, to be connected, installed, removed, swapped, and/or exchanged by a user in conjunction with another item, such as an optical assembly 200 of a head-mounted device. Connection of a lens assembly 210 with an optical assembly 200 can be performed and reversed, followed by disconnection and connection of another lens assembly 210 with the same optical assembly 200 or another optical assembly 200 with the same lens assembly 210. As such, multiple lens assemblies 210 can be exchangeable with each other with respect to a given optical assembly 200. Further, multiple optical assemblies 200 can be used with any given lens assembly 210.

A lens assembly 210 can be connected to an optical assembly 200 in a manner that allows the lens assembly 210 to be removed thereafter. The connection can be fully reversible, such that when the lens assembly 210 and the optical assembly 200 are disconnected, each is restored to a condition held prior to the connection. The connection can be fully repeatable, such that after the lens assembly 210 and the optical assembly 200 are disconnected, the same or a different optical assembly 200 and lens assembly 210 pair can be connected in the same way.

A lens assembly 210 and an optical assembly 200 can be connected in a manner that secures the relative positions of the lens assembly 210 and the optical assembly 200 with respect to each other. For example, the lens assembly 210 can include one or more lens assembly connectors 212 (e.g., magnets). Optical assembly connectors 202 can facilitate coupling of the lens assembly 210 to optical assembly connectors 202 of the optical assembly 200 in a relative position and orientation that aligns the lens assembly 210 in a preferred position and orientation relative to the optical assembly 200, the display 140, and/or the frame 110. It will be understood that such placement can be reversible to allow the user to exchange the lens assemblies 210 for different lens assemblies 210 as needed, for example when another user operates the head-mountable device. One or more of various mechanisms can be provided to secure a lens assembly 210 to an optical assembly 200. For example, mechanisms for the connectors 212 and 202 can include locks, latches, snaps, slides, channels, screws, clasps, threads, magnets, pins, an interference (e.g., friction) fit, knurl presses, bayoneting, fused materials, weaves, knits, braids, hook and loop fasteners, and/or combinations thereof can be included to couple and/or secure the lens assembly 210 to the optical assembly 200. The components can remain secured to each other until an optional release mechanism is actuated. The release mechanism can be provided for access by a user.

While only one set of connectors 212 and 202 are illustrated in FIG. 1, it will be understood that each lens assembly can provide its own connectors, and each optical assembly 200 can include any number of optical assembly connectors 202 to securely receive as many lens assemblies as desired. For example, an optical assembly 200 can include first optical assembly connectors for receiving a first lens assembly, second optical assembly connectors for receiving a second lens assembly, third optical assembly connectors for receiving a third lens assembly, and so on.

The lens assembly 210 and the optical assembly 200 can be connected in a manner that provides a communication link there between. The secured positions and the communication link can both be achieved and maintained upon connection of the lens assembly 210 and the optical assembly 200. The secured positions and the communication link can both be removed upon disconnection of the lens assembly 210 from the optical assembly 200. For example, the connectors 212 and 202 can each provide a communication interface. The communication interfaces can include one or more conductive contacts (e.g., electrodes) that are configured to make electrical contact with another conductive contacts (e.g., electrodes) when the lens assembly 210 is coupled to the optical assembly 200 (e.g., by the connectors 212 and 202). Additionally or alternatively, the connectors 212 and 202 can include communication interfaces that are manually connected to establish a communication interface. Such connectors can include ZIF connectors, non-ZIF connectors, slider connectors, flip actuator connectors, and/or FPC-to-Board connectors. In some examples, the communication interfaces can be separate and independent of the connectors 212 and 202. Optionally, the communication interfaces can be connected when the connectors 212 and 202 are coupled together. Additionally or alternatively, the communication interfaces can facilitate wireless communication.

Each of the lens assemblies 210 can have a known type of correction based on the identity thereof. Corresponding identifiers, such as stock keeping units (“SKU”), can be assigned for reference and to facilitate selection of a lens assembly 210 for a given user. Accordingly, different users can use different lens assemblies 210 as desired. Each lens assembly 210 can include an identifier 214 corresponding to the lens assembly 210 and/or the user. For example, a lens of any given lens assembly 210 can provide a known type of vision correction based on the identity thereof. Such a lens can be selected for a user based on an eye exam, prescription, and/or selection by a user. Information corresponding to the type of lens can be stored on the identifier 214 of the lens assembly 210. For example, the identifier 214 can include a memory or other storage device. The information stored on the identifier 214 can include an indicator (e.g., SKU) corresponding to the lens assembly 210, a type of vision correction provided by the lens assembly 210, and/or other information that can be used by the head-mountable device 100. For example, the head-mountable device 100 may adjust an aspect of the optical assembly 200 and/or the output of the display 140 based on the determined lens assembly 210 being used at any given time.

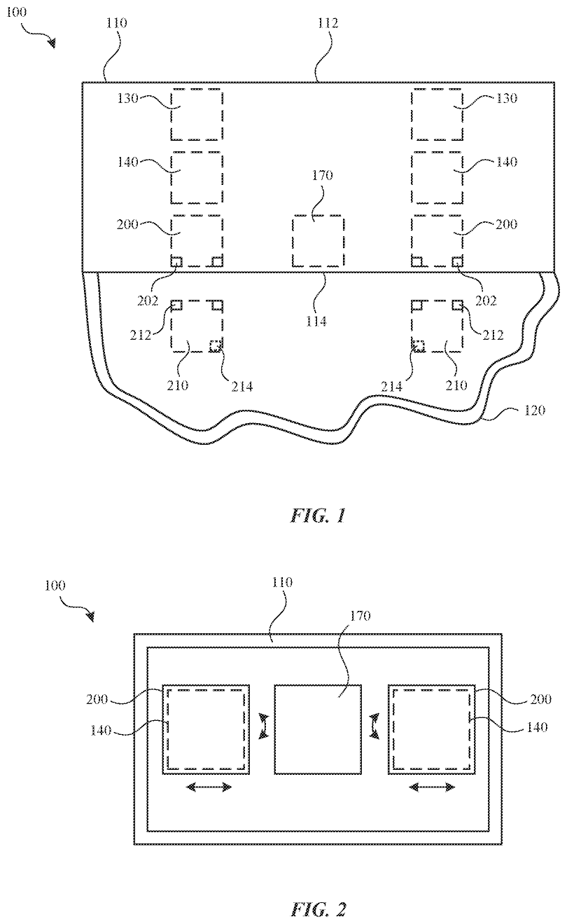

Referring now to FIG. 2, the optical assemblies of the head-mountable device can be adjustable to accommodate the facial features of the user wearing the head-mountable device and align each optical assembly with a corresponding eye of the user.

As shown in FIG. 2, the frame 110 can support a sensor 170. The sensor 170 can be positioned and arranged to detect a characteristic of the user, such as facial features. For example, such a user sensor can perform facial feature detection, facial movement detection, facial recognition, eye tracking, user mood detection, user emotion detection, voice detection, and the like.

As further shown in FIG. 2, each display 140 and optical assembly 200 can be adjusted to align with a corresponding eye of the user. For example, each display 140 and optical assembly 200 can be moved along one or more axes until a center of each display 140 and optical assembly 200 is aligned with a center of the corresponding eye. Accordingly, the distance between the displays 140 and the optical assemblies 200 can be set based on an interpupillary distance (“IPD”) of the user. IPD is defined as the distance between the centers of the pupils of a user's eyes.

The pair of displays 140 and optical assemblies 200 can be mounted to the frame 110 and separated by a distance. In some embodiments, the distance between the pair of displays 140 and optical assemblies 200 can be designed to correspond to the IPD of a user. The distance can be adjustable to account for different IPDs of different users that may wear the head-mountable device 100. For example, either or both of the optical displays 140 and optical assembly 200 may be movably mounted to the frame 110 to permit the displays 140 and optical assemblies 200 to move or translate laterally to make the distance larger or smaller. Any type of manual or automatic mechanism may be used to permit the distance between the displays 140 and optical assemblies 200 to be an adjustable distance. For example, the displays 140 and optical assemblies 200 can be mounted to the frame 110 via slidable tracks or guides that permit manual or electronically actuated movement of one or more of the displays 140 and optical assemblies 200 to adjust the distance there between.

In some embodiments, the orientation of the pair of displays 140, the optical assemblies 200, and/or components thereof (e.g., lens assemblies and/or lenses) can be adjusted as needed. For example, the orientation of some lenses can alter the vision correction properties thereof. As such, the rotational orientation about an optical axis can be controlled as needed.

Additionally or alternatively, the displays 140 and optical assemblies 200 can be moved to a target location based on a desired visual effect that corresponds to user's perception of the displays 140 and optical assemblies 200 when it is positioned at the target location. The target location can be determined based on a focal length of the user and/or optical elements of the system. For example, the user's eye and/or optical elements of the optical assembly 200 can determine how the visual output of the displays 140 will be perceived by the user. The locations and/or orientations of the displays 140 and/or the optical assemblies 200 (e.g., with respect to the user's eyes) can be altered to place the output at, within, or outside of a corresponding focal distance. Such adjustments can be useful to accommodate a particular user's eye, corrective lenses, and/or a desired optical effect.

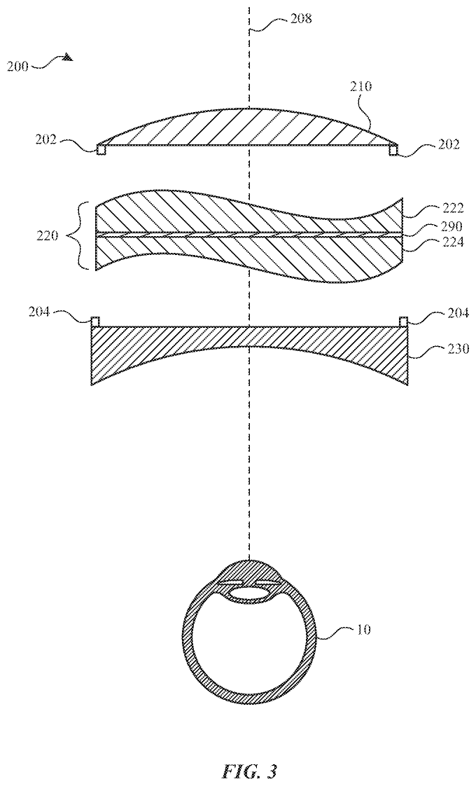

Referring now to FIG. 3, an optical assembly can include adjustable lenses and installable lens assemblies to produce combined optical effects for vision correction.

As shown in FIG. 3, the optical assembly 200 can include multiple lenses arranged along an optical axis 208. The optical effects of the various lenses can provide a combined vision correction according to the needs of the eye 10 that observes a view through the optical assembly 200 along the optical axis 208.

The optical assembly 200 can include one or more lens assemblies, each providing a consistent (e.g., non-adjustable) optical property for vision correction. Despite having a consistent optical property, the lens assemblies can be provided to the optical assembly in a releasable manner, such that the lens assemblies can be removed and/or exchanged with other lens assemblies that provides a different optical property for vision correction, as described herein.

The optical assembly 200 can further include one or more adjustable lenses, each providing an adjustable optical property for vision correction. By providing an adjustable capability, the adjustable lens can be durably installed (e.g., not readily removable) into the optical assembly, as described herein.

For example, an adjustable lens 220 can provide a vision correction based on the position of multiple lenses, such as first lens 222 and a second lens 224. The first lens 222 and the second lens 224 can be positioned at different locations along the optical axis 208. The positions of the first lens 222 and the second lens 224 can determine the combined optical properties of the adjustable lens 220, as described further herein. For example, the adjustable lens 220 can be adjusted to provide spherical vision correction with an optical power within the range, such as −3.0 to +3.0, −4.0 to +4.0 diopter, −5.0 to +5.0, and the like. It will be understood that any range can be selected, including a variety of position and/or negative diopter of optical power. The first lens 222 and the second lens 224 can be moved to achieve any given optical power within the range.

As shown in FIG. 3, the optical assembly 200 can receive and/or include a first lens assembly 210 and/or a second lens assembly 230 to further adjust the range that can be achieved. The first lens assembly 210 can be positioned on a first side (e.g., facing away from the eye 10) of an adjustable lens 220, and the second lens assembly 230 can be positioned on a second side (e.g., facing toward the eye 10) of the adjustable lens 220.

The first lens assembly 210 and/or the second lens assembly 230 can be connected to the optical assembly 200 in a manner that secures their positions and/or orientations within the system. For example, the optical assembly 200 can include one or more first optical assembly connectors 202 (e.g., magnets) to engage corresponding connectors of the first lens assembly 210 (see FIG. 1), as well as one or more second optical assembly connectors 204 (e.g., magnets) to engage corresponding connectors of the second lens assembly 230. Optical assembly connectors 202 and 204 can facilitate coupling of the first lens assembly 210 and/or the second lens assembly 230, respectively, in a corresponding position and/or orientation relative to the optical assembly 200, the display, and/or the frame. It will be understood that such placement can be reversible to allow the user to exchange the first lens assembly 210 and/or the second lens assembly 230 for a different first lens assembly and/or second lens assembly as needed, for example when another user operates the head-mountable device. One or more of various mechanisms can be provided for the first optical assembly connectors 202 and/or the second optical assembly connectors 204. For example, such mechanisms can include locks, latches, snaps, slides, channels, screws, clasps, threads, magnets, pins, an interference (e.g., friction) fit, knurl presses, bayoneting, fused materials, weaves, knits, braids, hook and loop fasteners, and/or combinations thereof can be included to couple and/or secure the first lens assembly 210 and/or the second lens assembly 230 to the optical assembly 200. The components can remain secured to each other until an optional release mechanism is actuated. The release mechanism can be provided for access by a user.

The first lens assembly 210 can provide, for example, a spherical correction with a positive diopter of optical power. For example, the diopter of the first lens assembly 210 can be +2.0 diopter, +2.5 diopter, +3.0 diopter, and the like. By providing the first lens assembly 210, the range of the optical assembly 200 can be shifted from the range of the adjustable lens 220 alone. For example, by providing the first lens assembly 210, the optical power of the adjustable lens 220 can shift from −4.0 to +4.0 diopter to a maximum of +6.5 diopter of optical power (e.g., with a first lens assembly 210 of +2.5 diopter of optical power). By further example, omitting the first lens assembly 210 can result in a corresponding change in the effective range of the optical assembly 200.

The second lens assembly 230 can provide, for example, a spherical correction with a negative diopter of optical power. For example, the diopter of the second lens assembly 230 can be −6.0 diopter, −6.5 diopter, −7.0 diopter, and the like. By providing the second lens assembly 230, the range of the optical assembly 200 can be shifted from the range of the adjustable lens 220 alone. For example, by providing the second lens assembly 230, the optical power of the adjustable lens 220 can shift from −4.0 to +4.0 diopter to a minimum of −10.5 diopter of optical power (e.g., with a first lens assembly 210 of −6.5 diopter of optical power and the adjustable lens 220 in a configuration to provide −4.0 diopter of optical power). By further example, omitting the second lens assembly 230 can result in a corresponding change in the effective range of the optical assembly 200.

It will be understood that only one of the first lens assembly 210 or the second lens assembly 230 need be provided to achieve corresponding maximum and minimum diopters of optical power. For example, to increase the effective range of optical power for the optical assembly (e.g., up to +6.5 diopter), the first lens assembly 210 can be provided without the second lens assembly 230. By further example, to decrease the effective range of optical power for the optical assembly (e.g., down to −6.5 diopter), the second lens assembly 230 can be provided without the first lens assembly 210. It will be further understood that neither lens assembly need to provided where the desired correction is within the unmodified range of the adjustable lens 220 (e.g., within −4.0 to +4.0 diopter). It will be further understood that the number of types (e.g., SKUs) of lens assemblies that need be provided can be simplified, such that as few as only one type of first lens assembly 210 and one type of second lens assembly 230 may be offered. By combining the selection to include or omit either or both with the adjustability of the adjustable lens 220, the optical assembly can provide a wide range of optical power. As such, the user need not choose from a wide range of lenses or rely solely on custom lenses to provided the needed vision correction.

Optionally, the optical assembly 200 can include one or more fixed lenses that need not be adjustable or removable. Rather, such fixed lenses can provide a base level of vision correction that can be augmented by the other lenses described herein, such as the lens assemblies and/or the adjustable lenses.

As further shown in FIG. 3, the adjustable lens 220 can include a lubricious coating 290 between the first lens 222 and the second lens 224. For example, the first lens 222 and the second lens 224 can have flat and/or plainer surfaces facing each other. At the interface between the lenses, it can be desirable to minimize refraction and reflection, such that life is largely transmitted along the optical axis 208. As such, the lubricious coating 290 can be provided between the lenses and have an index of refraction that does not exceed an index of refraction of either one of the first lens 222 or the second lens 224.

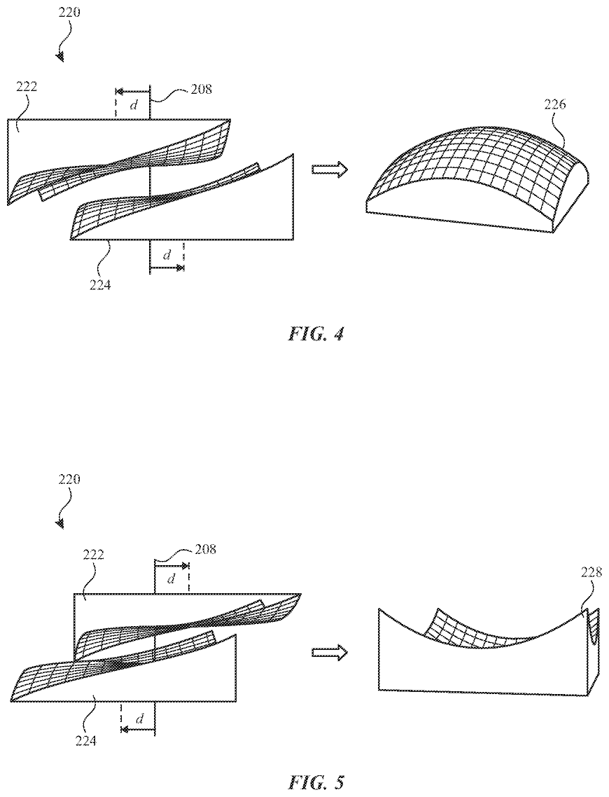

Referring now to FIGS. 4 and 5, the adjustable lens can provide variable vision correction based on movement of the constituent lenses. For example, the adjustable lens can be an Alvarez lens. A typical Alvarez lens contains a pair of lenses 222 and 224 with complementary cubic surface profiles. Optical power modulation is achieved by the relative lateral displacement between the two lenses 222 and 224 in a direction perpendicular to the optical axis 208.

As shown in FIGS. 4 and 5, the adjustable lens 220 comprises two lenses 222 and 224 with identical, non-rotationally symmetric surfaces placed in series but oriented in a complementary configuration.

The thickness, t, of either one of the lenses, as measured parallel to the optical axis 208 (i.e., the Z-axis), can be given by the equation:

$$t = A ( {xy}^{2} + \frac{{x}^{3}}{3} ) ,$$

where x and y represent the location along the corresponding X-axis and Y-axis, respectively. The term A is defined by the following equation:

$$A = \frac{Δφ}{2 d ( n - 1 )} ,$$

where Δφ is the desired optical power change, d is the displacement of each of the lenses relative to the optical axis 208, and n is the refractive index of the material used to fabricate the lenses.

As further shown in FIGS. 4 and 5, when the lenses 222 and 224 are translated in a direction perpendicular to the optical axis 208 (e.g., along an X-axis) in opposing directions, the net changes in optical power generate continuously variable spherical correction and/or power whose magnitude and sign depend on the magnitude (i.e., distance, d) and direction of the translations. For example, as shown in FIG. 4, while the lenses 222 and 224 are in first positions the adjustable lens 220 produces a first effective vision correction 226 (e.g., with positive diopter). As shown in FIG. 5, while the lenses 222 and 224 are in second positions the adjustable lens 220 produces a second effective vision correction 228 (e.g., with negative diopter).

It will be understood that while the curved surfaces of the lenses 222 and 224 in FIGS. 4 and 5 are facing each other, other arrangements are contemplated, such as with the opposing sides (e.g., flat sides) of each facing each other. In such an embodiment, the interface can be consistently spaced with, for example, a lubricious coating as described herein.

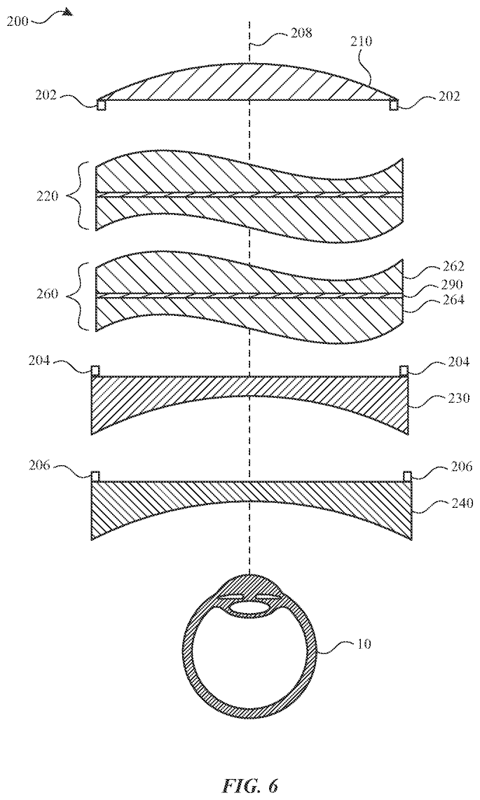

Referring now to FIG. 6, cylindrical correction can be provided by an optical assembly that includes a particular lens assembly and/or adjustable lens. As shown in FIG. 6, the optical assembly 200 can include multiple lenses arranged along an optical axis 208 to provide cylindrical vision correction in addition to or as an alternative to spherical correction. Such optical effects of the various lenses can provide a combined vision correction according to the needs of the eye 10 that observes a view through the optical assembly 200 along the optical axis 208. For example, in addition to the first lens assembly 210, the adjustable lens 220, and/or the second lens assembly 230, the optical assembly 200 can include an adjustable lens 260 for providing cylindrical vision correction and/or a third lens assembly 240 for providing cylindrical vision correction.

As shown in FIG. 6, the optical assembly 200 can receive and/or include a third lens assembly 240. The third lens assembly 240 can optionally be positioned on the second side (e.g., facing toward the eye 10) of the adjustable lens 220 and/or the adjustable lens 260 (if present). The second lens assembly 230 can provide, for example, a cylindrical correction with a negative diopter of optical power. For example, the selected third lens assembly 240 can be one among lens assemblies that provide −0.5 diopter, −0.75 diopter, −1.0 diopter, −1.25 diopter, −1.5 diopter, −1.75 diopter, −2.0 diopter, −2.25 diopter, −2.5 diopter, −2.75 diopter, −3.0 diopter, −3.25 diopter, −3.5 diopter, −3.75 diopter, −4.0 diopter, −4.25 diopter, or −4.5 diopter. While these are examples, the available lens assemblies can be of any optical power with any value of intervals (e.g., 0.25 diopter) separating them from each other, so that a user can select the one that best approximates the vision correction needed. It will be understood that orientation of the cylindrical correction can also vary among available lens assemblies, so that the user can similarly select the one that best approximates the vision correction needed.

The third lens assembly 240 can be connected to the optical assembly 200 in a manner that secures its position and/or orientation within the system. For example, the optical assembly 200 can include one or more third optical assembly connectors 206 (e.g., magnets) to engage corresponding connectors of the third lens assembly 240. While such connectors are not shown in FIG. 6, the connectors can be similar to the connectors 202 shown in FIG. 1 with the description thereof given herein. Optical assembly connector(s) 206 can facilitate coupling of the third lens assembly 240 in a position and/or orientation relative to the optical assembly 200, the display, and/or the frame. It will be understood that such placement can be reversible to allow the user to exchange the third lens assembly 240 for a different third lens assembly as needed, for example when another user operates the head-mountable device. One or more of various mechanisms can be provided for the third optical assembly connectors 206. For example, such mechanisms can include locks, latches, snaps, slides, channels, screws, clasps, threads, magnets, pins, an interference (e.g., friction) fit, knurl presses, bayoneting, fused materials, weaves, knits, braids, hook and loop fasteners, and/or combinations thereof can be included to couple and/or secure the third lens assembly 240 to the optical assembly 200. The components can remain secured to each other until an optional release mechanism is actuated. The release mechanism can be provided for access by a user.

In some embodiments, an adjustable lens 260 is provided to produce vision correction based on the position of multiple lenses, such as first lens 262 and a second lens 264. The first lens 262 and the second lens 264 can each have a variable thickness along one axis (e.g., an X-axis), rather than two (e.g., X-axis and Y-axis, as with the lenses of the spherical adjustable lens).

The first lens 262 and the second lens 264 can be positioned at different locations along the optical axis 208. The positions of the first lens 262 and the second lens 264 can determine the combined optical properties of the adjustable lens 260, as described further herein. For example, the adjustable lens 260 can be adjusted to provide cylindrical vision correction with an optical power within the range, such as −0.5 to −4.5, and the like. It will be understood that any range can be selected, including a variety of position and/or negative diopter of optical power. The first lens 262 and the second lens 264 can be moved to achieve any given optical power within the range.

The adjustable lens 260 can also have an adjustable orientation about the optical axis 208 to control the axis of cylindrical correction. For example, the optical assembly 200 can control the rotational orientation of the adjustable lens 260 to match the cylindrical vision correction needed by the eye 10 of the user. Such adjustments can be effected and controlled, for example, by an actuator that rotates the adjustable lens 260 about the optical axis 208.

It will be understood that only one of the third lens assembly 240 or the adjustable lens 260 need be provided to achieve corresponding cylindrical correction. For example, where the adjustable lens 260 is provided, neither the lens assembly 240 nor corresponding connectors to receive it need be included in the optical assembly 200. By further example, where the third lens assembly 240 is provided to corresponding connectors of the optical assembly 200, the adjustable lens 260 may not be needed. Optionally, both the third lens assembly 240 and the adjustable lens 260 can be provided to produce a combined optical effect.

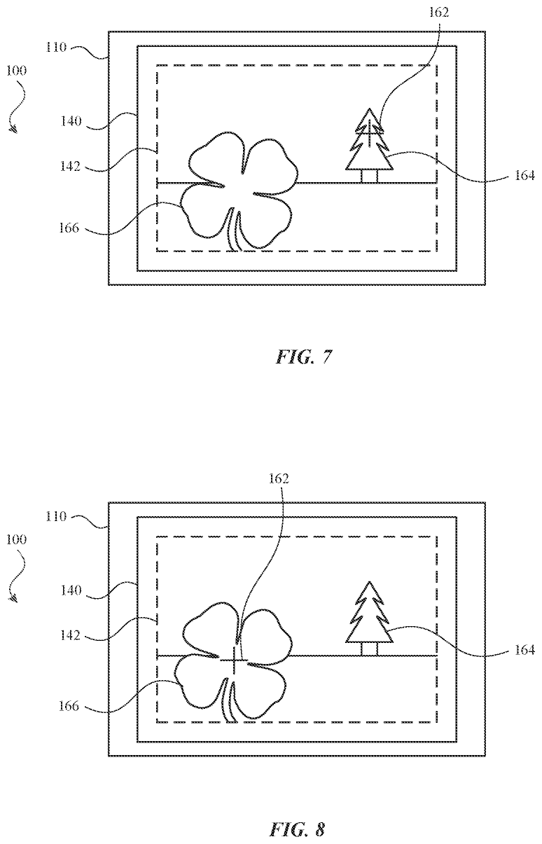

Referring now to FIGS. 7 and 8, the head-mountable device can operate adjustable lenses to provide different optical effects based on the gaze of the user and/or the objects presented for display.

Under natural conditions, as a user observes an object, the eyes can adjust to cause vergence and accommodation, such that the vergence depth matches the focal length of the eyes. Head-mountable devices may create depth perceptions of objects at distances which are different from the fixed distance between a user's eyes and a display. Under normal conditions, changing the focus of the eyes to look at an object at a different distance automatically causes vergence and accommodation. There can be some difference between the vergence depth and focal length such that the user's eyes cannot verge and accommodate at the same time, which is referred herein as a “vergence-accommodation conflict.”

As shown in FIGS. 7 and 8, a head-mountable device can provide a user interface 142 that allows a user to observe an environment provided with particular optical effects. The display 140 can provide the user interface 142 to be viewed through an optical assembly with various lens assemblies and/or adjustable lenses. Not all of the depicted graphical elements may be used in all implementations, however, and one or more implementations may include additional or different graphical elements than those shown in the figure. Variations in the arrangement and type of the graphical elements may be made without departing from the spirit or scope of the claims as set forth herein. Additional components, different components, or fewer components may be provided.

As further shown in FIGS. 7 and 8, the user interface can present various objects, including far objects 164 and near objects 166. It will be understood that the objects can represent objects in a physical environment and/or a virtual environment. Depending on the direction of the user's gaze (e.g., to be directed to a far object 164 or a near object 166), the adjustable lenses can be controlled to provide different optical effects. In FIGS. 7 and 8, the direction of the user's gaze is represented by the target 162, but such a symbol need not be included in the user interface.

Based on the user's gaze and the effective distance (e.g., real or simulated) of an object at the distance, the depth of focus of an adjustable lens can be controlled to be greater than the user's uncorrected or corrected vision depth of focus. This can cause a combined vision from both eyes of the user to provide a substantially in focus image of the corresponding object output by the display 140 at about a fixed distance from the user. For example, the depth of focus provide by the adjustable lens can exceed the user's uncorrected or corrected vision depth of focus by at least 0.5-4.0 diopter. In some embodiments, an adjustable lens can provide combined vision from both eyes of the user to provide a vergence-accommodation relationship similar to a natural viewing condition, which reduces at least a mismatch or a conflict. In some embodiments, the adjustable lens of one optical assembly can be controlled to provide near vision correction for one eye, and/or the adjustable lens of another optical assembly can be controlled to provide far vision correction for the other eye. Such an operation can allow one eye to focus on a near object 166 and the other eye to focus on a far object 164.

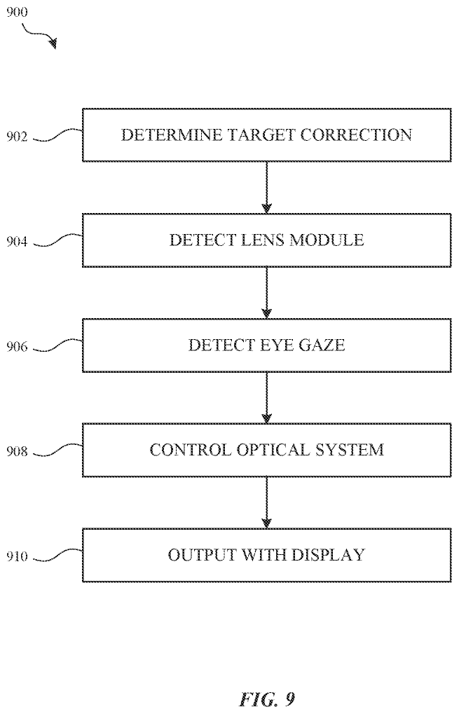

FIG. 9 illustrates a flow diagram of an example process 900 for operating a head-mountable device with a lens assembly. For explanatory purposes, the process 900 is primarily described herein with reference to the head-mountable device 100. However, the process 900 is not limited to head-mountable device 100 or any one component thereof and one or more blocks (or operations) of the process 900 may be performed by different components of the head-mountable device and/or one or more other devices. Further for explanatory purposes, the blocks of the process 900 are described herein as occurring in serial, or linearly. However, multiple blocks of the process 900 may occur in parallel. In addition, the blocks of the process 900 need not be performed in the order shown and/or one or more blocks of the process 900 need not be performed and/or can be replaced by other operations.

The process 900 can begin when the head-mountable device determines a target correction to be provided to a user (902). The determination can be based on a prescription, a diagnosis, results of an eye test, results of examining existing glasses, and/or user preference selections. Such a determination can involve determining the user and retrieving that user's vision correction needs.

The head-mountable device can detect one or more lens assemblies provided to an optical assembly of the head-mountable device (904). For example, the head-mountable device can communicate with or otherwise sense an identifier of a lens assembly, which can be used to determine its identity, such as with a SKU. Each lens assembly that could be provided can have spherical, cylindrical, and/or another type of correction. The differences in correction among multiple lens assemblies can include variations in a type of correction, diopter power, axis of correction, and the like. Each correction type or combination of correction types can be identified by the identifier, so that the head-mountable device can determine the optical contribution of the installed lens assembly.

The head-mountable device can detect an eye gaze of the user (906). For example, a user sensor (e.g., eye sensor) can detect a direction in which each of the user's eyes is oriented. The head-mountable device can further determine a distance or effect (e.g., actual or simulated) distance to an object along the path of the user's gaze.

The head-mountable device can control one or more aspects of an optical assembly (908). For example, the head-mountable device can control an adjustable lens so that the total optical assembly provides a combined vision correction in view of other lenses (e.g., lens assemblies) that are installed. For example, the adjustable lenses can be moved to provided a particular spherical and/or cylindrical vision correction. By further example, the axis of cylindrical vision correction can be controlled by rotating the adjustable lens about an optical axis. Such adjustments can be made to achieve the target correction previously determined.

The head-mountable device can operate a display to provide an output (910). For example, the visual output or other operation of a display can be controlled and/or altered based on the identification of a lens assembly, user, setting, and/or physical environment. Optionally, the process 900 can be repeated as needed to detect the addition and/or removal of a lens assembly, a change of user, a change in eye gaze direction, and the like.

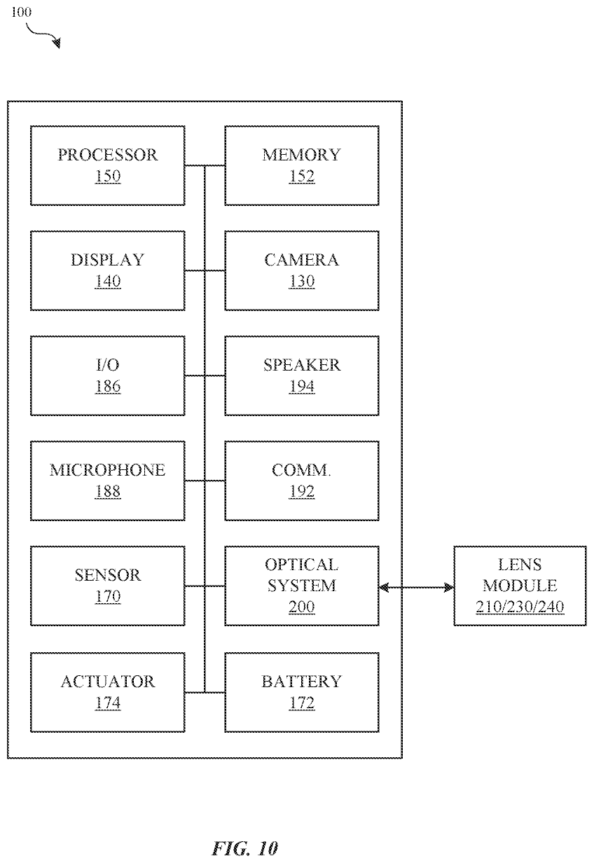

Referring now to FIG. 10, components of the head-mountable device can be operably connected to provide the performance described herein. FIG. 10 shows a simplified block diagram of an illustrative head-mountable device 100 in accordance with one embodiment of the invention. It will be appreciated that components described herein can be provided on one, some, or all of a frame, a lens assembly, and/or a head engager. It will be understood that additional components, different components, or fewer components than those illustrated may be utilized within the scope of the subject disclosure.

As shown in FIG. 10, the head-mountable device 100 can include a processor 150 (e.g., control circuity) with one or more processing units that include or are configured to access a memory 152 having instructions stored thereon. The instructions or computer programs may be configured to perform one or more of the operations or functions described with respect to the head-mountable device 100. The processor 150 can be implemented as any electronic device capable of processing, receiving, or transmitting data or instructions. For example, the processor 150 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements. The processor can be a component of and/or operably connected to the control board and/or another component of the head-mountable device.

The memory 152 can store electronic data that can be used by the head-mountable device 100. For example, the memory 152 can store electrical data or content such as, for example, audio and video files, documents and applications, device settings and user preferences, timing and control signals or data for the various modules, data structures or databases, and so on. The memory 152 can be configured as any type of memory. By way of example only, the memory 152 can be implemented as random access memory, read-only memory, Flash memory, removable memory, or other types of storage elements, or combinations of such devices.

The head-mountable device 100 can include adjustment control components described herein, such as an actuator 174, a motor, and the like for moving components (e.g., adjustable lenses, lenses, and/or lens assemblies of an optical assembly 200) to a desired relative position and/or orientation.

The head-mountable device 100 can include one or more sensors 170, such as the sensors of a sensor assembly, as described herein.

The head-mountable device 100 can include an input/output component 186, which can include any suitable component for connecting head-mountable device 100 to other devices. Suitable components can include, for example, audio/video jacks, data connectors, or any additional or alternative input/output components. The input/output component 186 can include buttons, keys, or another feature that can act as a keyboard for operation by the user.

The head-mountable device 100 can include the microphone 188 as described herein. The microphone 188 can be operably connected to the processor 150 for detection of sound levels and communication of detections for further processing, as described further herein.

The head-mountable device 100 can include the speakers 194 as described herein. The speakers 190 can be operably connected to the processor 150 for control of speaker output, including sound levels, as described further herein.

The head-mountable device 100 can include communications circuitry 192 for communicating with one or more servers or other devices using any suitable communications protocol. For example, communications circuitry 192 can support Wi-Fi (e.g., a 802.11 protocol), Ethernet, Bluetooth, high frequency systems (e.g., 900 MHZ, 2.4 GHZ, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. Communications circuitry 192 can also include an antenna for transmitting and receiving electromagnetic signals.

The head-mountable device 100 can include a battery 172, which can charge and/or power components of the head-mountable device 100. The battery 172 can also charge and/or power components connected to the head-mountable device 100.

As shown in FIG. 10, the lens assemblies 210, 230, and/or 240 can be operably connected to the head-mountable device 100 via the optical assembly 200 (e.g., connectors thereof). Accordingly, every component of the head-mountable device 100 can be operably connected to every component (e.g., identifiers) of the lens assemblies 210, 230, and/or 240.

Accordingly, embodiments of the present disclosure provide a head-mountable device with an optical assembly that combines installable lens assemblies with built-in adjustable lenses that provide vision correction appropriate for any given user. By providing head-mountable devices with modular features and adjustable vision correction, certain lens assemblies can provide the desired vision correction for any given user and facilitate exchange with a different lens assembly for a different user.

Various examples of aspects of the disclosure are described below as clauses for convenience. These are provided as examples, and do not limit the subject technology.

Clause A: a head-mountable device comprising: a frame; a display supported by the frame; an optical assembly providing a view to the display, the optical assembly comprising: a lens assembly being removably coupled to the frame and comprising a lens and an identifier; and a pair of lenses moveable relative to each other to adjust an effective spherical correction; and a processor operably connected to the lens assembly while the lens assembly is removably coupled to the frame, the process being configured to control movement of the lenses based on the identifier of the lens assembly and a target vision correction of the optical assembly.

Clause B: a head-mountable device comprising: a frame; a display supported by the frame; and an optical assembly providing a view to the display, the optical assembly comprising: a pair of lenses moveable relative to each other to adjust an effective spherical correction; a first connector on a first side of the pair of lenses for releasably engaging a first lens assembly having a first spherical correction with a positive diopter; a second connector on a second side of the pair of lenses for releasably engaging a second lens assembly having a second spherical correction with a negative diopter; and a third connector on the second side of the pair of lenses for releasably engaging a third lens assembly having a cylindrical correction.

Clause C: a head-mountable device comprising: a display; and an optical assembly comprising a pair of lenses providing a view to the display along an optical axis, the lenses having lubricious coatings on surfaces of the lenses that are facing each other, the lubricious coatings having an index of refraction that does not exceed an index of refraction of the lenses.

One or more of the above clauses can include one or more of the features described below. It is noted that any of the following clauses may be combined in any combination with each other, and placed into a respective independent clause, e.g., clause A, B, or C.

Clause 1: the lenses have identical, non-rotationally symmetric surfaces oriented in a complementary configuration.

Clause 2: the processor is further configured to detect a direction of a gaze of a user wearing the head-mountable device, wherein the movement of the lenses is controlled further based on the direction of the gaze.

Clause 3: the lenses are moveable transverse to an optical axis extending through the lens assembly, the lenses, and the display.

Clause 4: the optical assembly comprises an optical assembly connector; and the lens assembly comprises a lens assembly connector configured to releasably secure the lens assembly to the optical assembly by engaging the optical assembly connector.

Clause 5: at least one of the optical assembly connector or the lens assembly connector comprises at least one of a magnet, a lock, a latch, a snap, a pin, or a threaded screw.

Clause 6: the optical assembly further comprises an additional lens, wherein the pair of lenses is between the lens assembly and the additional lens.

Clause 7: the additional lens has a positive diopter; and the lens assembly has a negative diopter.

Clause 8: a camera, wherein the display is configured to output a view captured by the camera; a microphone; a speaker; and a head engager configured to secure the frame to head of a user.

Clause 9: each of the first lens assembly, the second lens assembly, and the third lens assembly further comprises an identifier, wherein the head-mountable device comprises a processor configured to: detect the identifier; and control movement of the lenses based, at least in part, on the identifier.

Clause 10: the pair of lenses is a first pair of lenses; and the optical assembly further comprises a second pair of lenses moveable relative to each other to adjust an effective cylindrical correction.

Clause 11: the second pair of lenses are rotatable about an optical axis of the optical assembly.

Clause 12: the pair of lenses are moveable relative to each other to adjust an effective spherical correction.

Clause 13: the pair of lenses are moveable relative to each other to adjust an effective cylindrical correction.

Clause 14: the second pair of lenses are rotatable about the optical axis of the optical assembly.

As described herein, aspects of the present technology can include the gathering and use of data. The present disclosure contemplates that in some instances, gathered data can include personal information or other data that uniquely identifies or can be used to locate or contact a specific person. The present disclosure contemplates that the entities responsible for the collection, analysis, disclosure, transfer, storage, or other use of such personal information or other data will comply with well-established privacy practices and/or privacy policies. The present disclosure also contemplates embodiments in which users can selectively block the use of or access to personal information or other data (e.g., managed to minimize risks of unintentional or unauthorized access or use).

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A head-mountable device comprising:
a frame;
a display supported by the frame;
an optical assembly providing a view to the display, the optical assembly comprising:
a lens assembly being removably coupled to the frame and comprising a lens and an identifier; and
a pair of lenses moveable relative to each other to adjust an effective spherical correction; and
a processor operably connected to the lens assembly while the lens assembly is removably coupled to the frame, the processor being configured to control movement of the pair of lenses based on the identifier of the lens assembly and a target vision correction of the optical assembly.

2. The head-mountable device of claim 1, wherein the pair of lenses have identical, non-rotationally symmetric surfaces oriented in a complementary configuration.

3. The head-mountable device of claim 1, wherein the processor is further configured to detect a direction of a gaze of an eye, wherein the movement of the pair of lenses is controlled further based on the direction of the gaze.

4. The head-mountable device of claim 1, wherein the pair of lenses are moveable transverse to an optical axis extending through the lens assembly, the pair of lenses, and the display.

5. The head-mountable device of claim 1, wherein:
the optical assembly comprises an optical assembly connector; and
the lens assembly comprises a lens assembly connector configured to releasably secure the lens assembly to the optical assembly by engaging the optical assembly connector.

6. The head-mountable device of claim 5, wherein at least one of the optical assembly connector or the lens assembly connector comprises at least one of a magnet, a lock, a latch, a snap, a pin, or a threaded screw.

7. The head-mountable device of claim 1, wherein the optical assembly further comprises an additional lens, wherein the pair of lenses is between the lens assembly and the additional lens.

8. The head-mountable device of claim 7, wherein:
the additional lens has a positive diopter; and
the lens assembly has a negative diopter.

9. The head-mountable device of claim 1, further comprising:
a camera, wherein the display is configured to output a view captured by the camera;
a microphone;
a speaker; and
a head engager configured to secure the frame to a head.

10. A head-mountable device comprising:
a frame;
a display supported by the frame; and
an optical assembly providing a view to the display, the optical assembly comprising:
a pair of lenses moveable relative to each other to adjust an effective spherical correction;
a first connector on a first side of the pair of lenses for releasably engaging a first lens assembly having a first spherical correction with a positive diopter;
a second connector on a second side of the pair of lenses for releasably engaging a second lens assembly having a second spherical correction with a negative diopter; and
a third connector on the second side of the pair of lenses for releasably engaging a third lens assembly having a cylindrical correction.

11. The head-mountable device of claim 10, wherein each of the first connector, the second connector, and the third connector comprises at least one of a magnet, a lock, a latch, a snap, a pin, or a threaded screw.

12. The head-mountable device of claim 10, wherein each of the first lens assembly, the second lens assembly, and the third lens assembly further comprises an identifier, wherein the head-mountable device comprises a processor configured to:
detect the identifier; and
control movement of the pair of lenses based, at least in part, on the identifier.

13. The head-mountable device of claim 10, wherein:
the pair of lenses is a first pair of lenses; and
the optical assembly further comprises a second pair of lenses moveable relative to each other to adjust an effective cylindrical correction.

14. The head-mountable device of claim 10, wherein the second pair of lenses are rotatable about an optical axis of the optical assembly.

15. The head-mountable device of claim 10, wherein the pair of lenses have identical, non-rotationally symmetric surfaces oriented in a complementary configuration.

16. A head-mountable device comprising:
a display; and
an optical assembly comprising a pair of lenses providing a view to the display along an optical axis, the pair of lenses having lubricious coatings on surfaces of the pair of lenses that are facing each other, the lubricious coatings having an index of refraction that does not exceed an index of refraction of the pair of lenses.

17. The head-mountable device of claim 16, wherein the pair of lenses are moveable relative to each other to adjust an effective spherical correction.

18. The head-mountable device of claim 16, wherein the pair of lenses are moveable relative to each other to adjust an effective cylindrical correction.

19. The head-mountable device of claim 18, wherein the second pair of lenses are rotatable about the optical axis of the optical assembly.

20. The head-mountable device of claim 16, wherein the pair of lenses have identical, non-rotationally symmetric surfaces oriented in a complementary configuration.
